(19) United States
(12) Patent Application Publication
(10) Pub. No.: US 2007/0115599 A1
(43) Pub. Date: May 24, 2007

(54) Fan system and method for protecting the same

(75) Inventors: Chien-Hua Chen, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/523,648

(22) Filed: Sep. 20, 2006

(30) Foreign Application Priority Data
Nov. 23, 2005 (TW) 94141109

(51) Int. Cl. H02H 5/04

(52) U.S. Cl. 361/104

(57) ABSTRACT

A fan system is electrically connected to a power supply and receives a power generated from the power supply. The fan system includes at least one fan, a driving circuit, at least one protecting device, and a protecting circuit. The driving circuit is electrically connected to the fan and receives the power to drive the fan. The protecting device is electrically connected with the fan, and the protecting circuit is electrically connected between the protecting device and the driving circuit. When one fan is short-circuited, the protecting circuit outputs a current value larger than a current-limited value of the protecting device. Also, a method for protecting a fan system is disclosed.

### RELATED APPLICATION

The present application is based on, and claims priority from, Taiwan Application Serial Number 94141109, filed Nov. 23, 2005, the disclosure of which is hereby incorporated by reference herein in its entirety.

### FIELD OF THE INVENTION

The present invention relates to a fan system and a method for protecting the fan system, and more particularly to the fan system and the protecting method thereof that can force the protecting devices to be burned out or fail when the fan system is short-circuited.

### BACKGROUND OF THE INVENTION

Referring to FIG. 1, FIG. 1 illustrates a conventional fan system 1 which is mainly constituted by a driving circuit 10, a capacitor C₁, several protecting devices 20 and several fans 30. The driving circuit 10 is electrically connected to a power supply 2, and has a switch device 11 and a driving device 12. One end of the capacitor C₁ is electrically connected to the driving circuit 10, and the other end of the capacitor C₁ is grounded. The protecting devices 20 are electrically connected with the fans 30 in series, respectively, and one end of each protecting device 20 is electrically connected in chorus with the capacitor C₁.

In the driving circuit 10, the switch device 11 is electrically connected between the power supply 2 and the capacitor C₁, and the driving device 12 is electrically connected between the power supply 2 and the switch device 11. The driving device 12 is used for controlling the on/off of the switch device 11. When the switch device 11 is turned on, the power generated from the power supply 2 can be transmitted to the capacitor C₁ for storing charges, and provides voltage and current inputted to the protecting device 20 and the fans 30 after storing the charges. If the protecting devices 20 (such as fuses) could be appropriately burned out as soon as any one of the fans 30 is short-circuited (for example, the isolation skin of the fan's internal wire is peeled off and the conductor part thereof touches a metal part inside the fan system.), then the short-circuit event could be isolated for protecting the driving circuit 10 at the front end and the fans 30 at the back end. However, as a matter of fact, since the protecting devices 20 are passive devices, a current-detecting device (not shown) installed in the driving device 12 will keep on receiving the detection of the short-circuit event if the short-circuit event fails to burn out the protecting devices 20, and thus the driving circuit 10 will be shut down due to failing to release the short-circuit event, and meanwhile, the switch device 11 will be turned off to cause all of the fans 30 at the back end to stop working so that the fan system 1 will fail to take charge of the load of heat dissipation due to insufficient heat dissipation, and eventually the whole system will be down or the overheat damage will be resulted in.

### SUMMARY OF THE INVENTION

In view of the above issue, an aspect of the present invention is to provide a fan system and a method for protecting the fan system having an active-type protecting function, wherein the protecting devices are forced to be burned out or fail when a short-circuit event occurs, thereby avoiding misjudgment and false response.

Hence, in accordance the aforementioned aspect, the present invention discloses a fan system electrically connected to a power supply, and receives a power generated from the power supply. The fan system mainly includes a driving circuit, a protecting circuit, at least one protecting device and at least one fan. The driving circuit is electrically connected to the fan, and receives the power to drive the fan The protecting device is electrically connected with the fan, and the protecting device is electrically connected with the driving circuit. The protecting circuit is electrically connected between the protecting device and the driving circuit. When one fan is short-circuited, the protecting circuit outputs a current value larger than the current-limited value of the protecting device corresponding to the fans, thereby making the protecting device fail for stopping the short-circuited fan from obtaining the power.

In accordance the aforementioned aspect, the present invention provides a method for protecting a fan system, wherein the fan system mainly includes a driving circuit, a protecting circuit, at least one protecting device and at least one fan The driving circuit is used for driving the fans, and the protecting circuit is electrically connected between the driving circuit and the fan. The protecting device is electrically connected with the fan, and the protecting device is electrically connected with the protecting circuit. The method includes steps of providing the above-mentioned fan system; and outputting a current value from the protecting circuit according to a current-limited value of the protecting devices when one fan is short-circuited. The current value is larger than the current-limited value of the protecting device corresponding to the fan. At the results, the protecting device fails wh en the fan is short-ircuited, thus stopping an operation of the short-circuited fan.

For clearly explaining the objects, features and advantages of the present invention, a preferred embodiment with accompanying figures is described in detail hereinafter.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a conventional fan system;

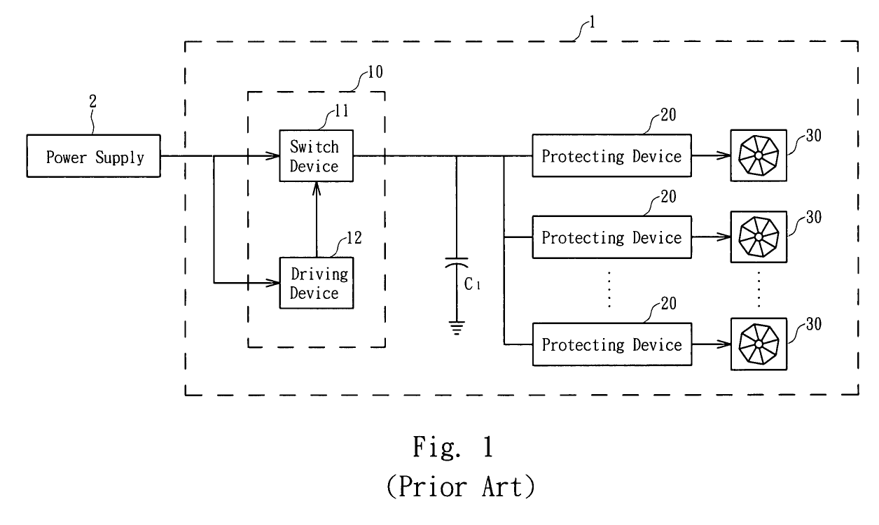

FIG. 2 is a schematic diagram of a fan system according to a preferred embodiment of the present invention;

FIG. 3 is a schematic diagram showing an implementation of the protecting circuit in the fan system of FIG. 2;

FIG. 4 is a circuit diagram showing one implementation of the driving circuit in the fan system of FIG. 2; and

FIG. 5 is a circuit diagram showing the other implementation of the driving circuit in the fan system of FIG. 2.

### DETAILED DESCRIPTION OF THE PREFERRED EMBODIMENT

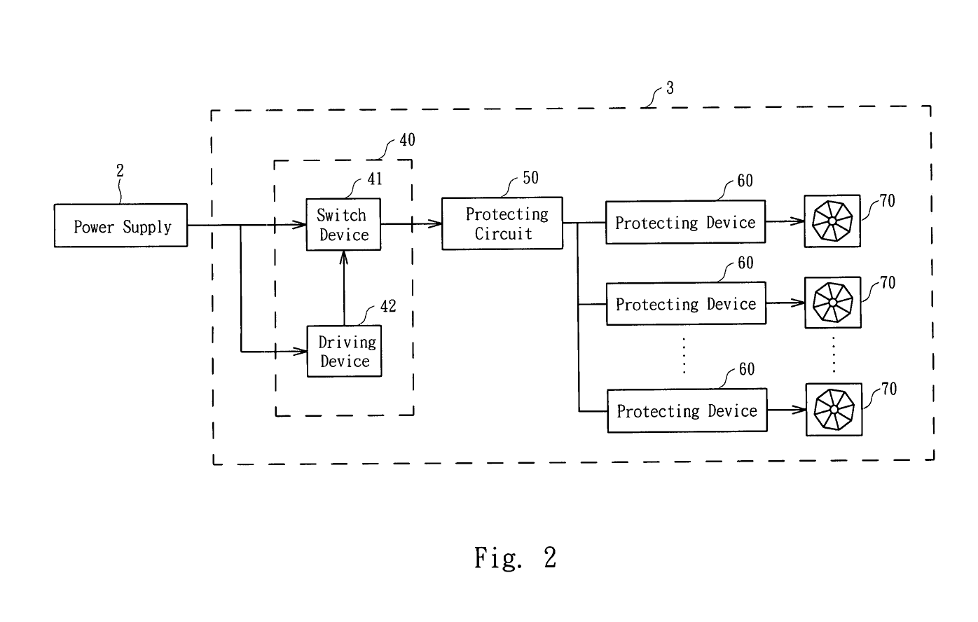

Referring to FIG. 2, FIG. 2 is a schematic diagram of a fan system 3 according to a preferred embodiment of the present invention. The fan system 3 includes a driving circuit 40, a protecting circuit 50, at least two protecting devices 60 and at least two fans 70. One end of the protecting circuit 40 is electrically connected to a power supply 2, and the protecting circuit 40 is constituted by a switch device 41 and a driving device 42. The protecting circuit 50 is electrically connected between the other end of the driving circuit 40 and the protecting devices 60. The protecting devices 60 are electrically connected to the fans 70 in series respectively, and one end of each of the protecting devices 60 is connected in chorus with the protecting circuit 50. As the results, each of the protecting devices and its corresponding fan 70 form an independent branched path.

The switch device 41 of the driving circuit 40 is electrically connected between the power supply 2 and the protecting circuit 50, and the driving device 42 is electrically connected between the power supply 2 and the switch device 41 for controlling the on/off of the switch device 41. When the switch device 41 is turned on, the power generated from the power supply 2 can be inputted to the protecting circuit 50. The protecting circuit 50 has the function of storing power, and whenever any one branched path is short-circuited, the protecting circuit 50 may deliver a current value greater than the current-limited value for each of the protecting devices 60 (i.e. the maximum current value that the protecting device can be sustained.). Under normal operation, the protecting circuit 50 is used for storing the charges of the power generated from the power supply 2, and after the charge-storing is completed, the protecting circuit 50 outputs current and voltage to the protecting devices 60 and the fans 70 for operating the fans 70.

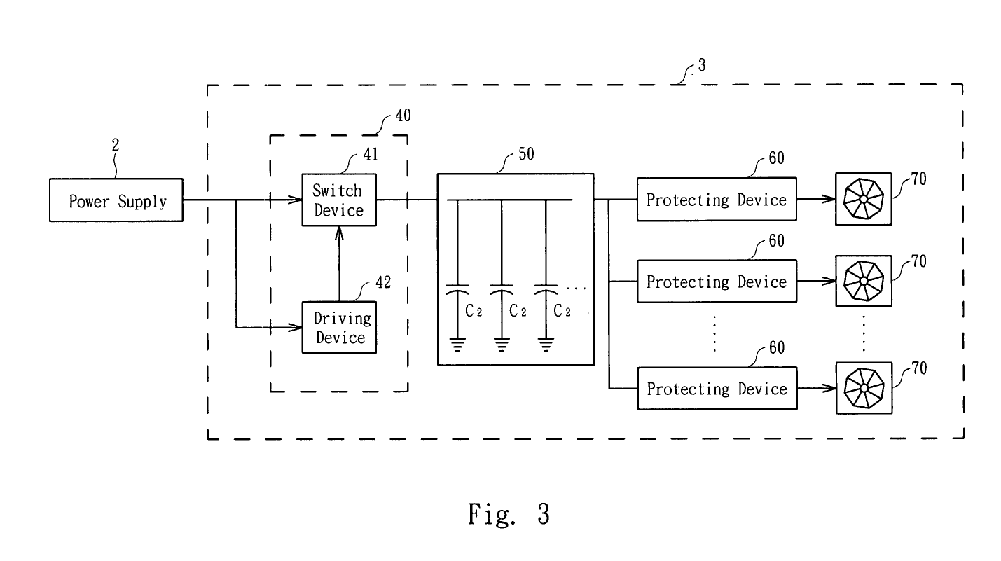

Referring to FIG. 3, in the present embodiment, the protecting circuit 50 is composed of several capacitors C₂ connected in parallel, and thus the protecting circuit 50 having a maximum capacitance value is formed. Accordingly, whenever any one branched path is short-circuited, the current outputted from the protecting circuit 50 may substantially flow only to the short-circuited branched path since tne short-circuited branched path has the smallest impedance than other branched paths. Additionally, for the large capacitance value generates large current, the protecting device 60 disposed on the short-circuited branched path can be forced to be burned out or become fail, thereby stopping the operation of the fan 70.

It is noted that the interruption of the short-circuited branched path does not affect the other branched paths, so that the output current from the protecting circuit 50 may be continuously distributed on the other branched paths for operating the other fans 70, thereby maintaining the heat-dissipation effect of the fan system 3. As the results, this not only prevents the driving circuit 40 from being shut down due to abnormal current, but also further effectively maintains the smoothness of the overall operation for the fan system 3.

Moreover, by using the feature of promptly interrupting the short-circuited branched path, the present invention has a response speed faster than the detection response of a current-detecting device (not shown) installed in the driving device 42, thereby ensuring the driving device 42 not to be shut down by any one short-circuited branched path, wherein the shut-down of the driving device 42 would make the fans 70 at the back end fail to provide heat-dissipation function.

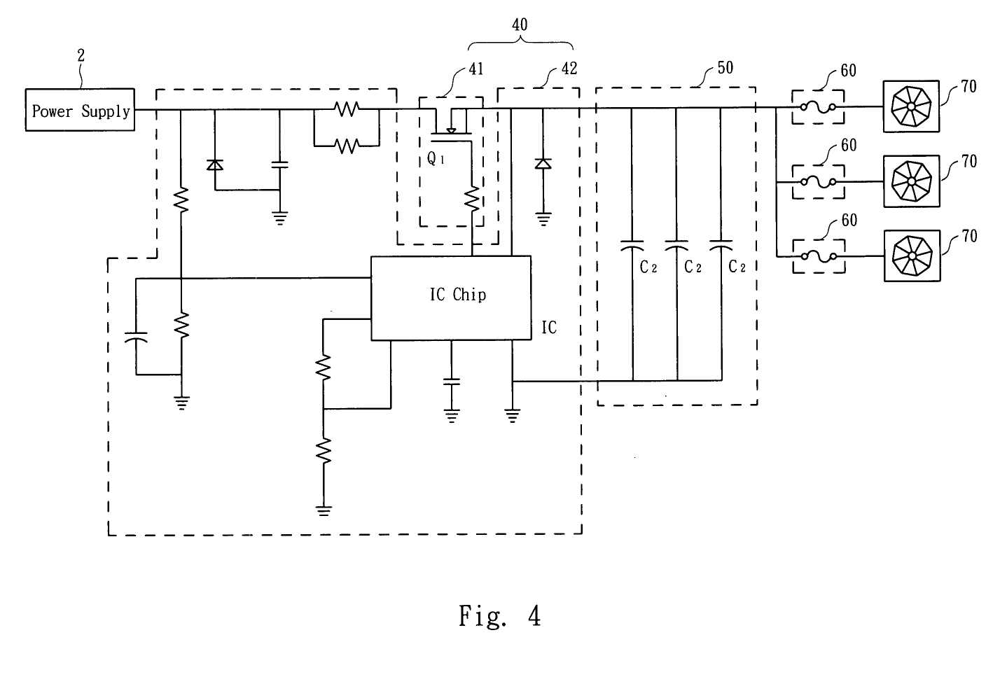

Referring to FIG. 4, in the fan system 3 of the present invention, the driving circuit 40 can be constructed by a combined software/hardware solution. The switch device 41 is a transistor Q₁, and in particularly to a NMOSFET (N-channel Metal-Oxide Semiconductor Field Effect Transistor). The driving device 42 mainly includes an integrated circuit (IC) chip for receiving the power generated from the power supply 2 so as to control the on/off of the switch device 41.

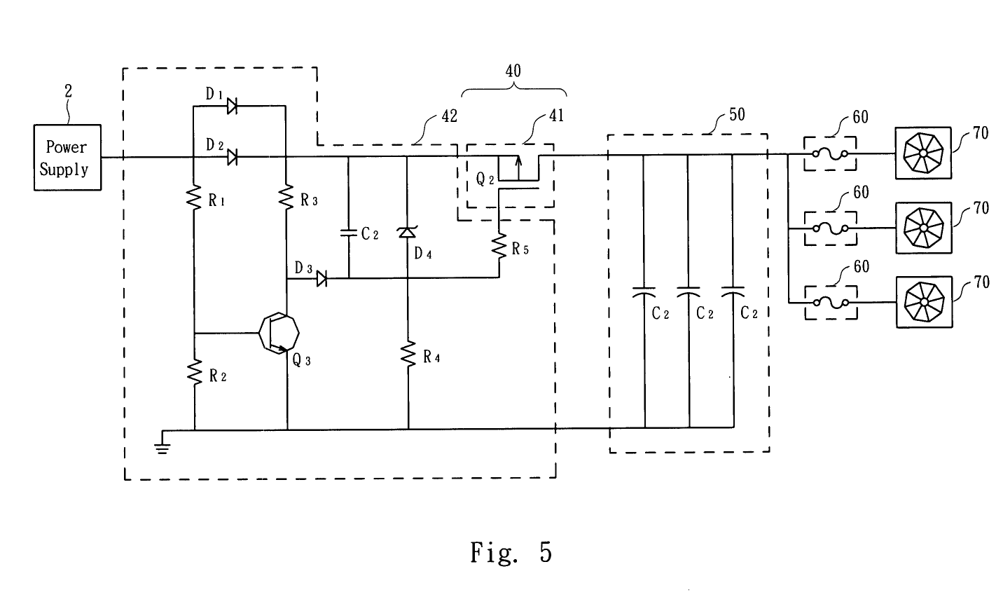

Referring to FIG. 5, in the fan system 3 of the present invention, the driving circuit 40 may be implemented as soft-start circuit, wherein the switch device 41 is transistor Q₂, and in particularly to a PMOSFET (P-channel Metal-Oxide Semiconductor Field Effect Transistor). The driving device 42 can include several resistors R₁-R₅, several diodes D₁-D₄, a transistor Q₃, a capacitor C₃ The driving device 42 receives the power generated from the power supply 2 to turn on the transistor Q₃, i.e. the activation of the transistor Q₃ is controlled accordingly.

To sum up, based on a fan system and a method for protecting the fan system according to the present invention, the fan system can force the protecting device to be burned out or fail via the protecting circuit when any one of the branched paths is short-circuited; and the method for protecting the fan system includes using the protecting circuit that can output a current value greater than the current-limited value of each of the protecting devices, so that the corresponding protecting device can be burned out or fail as soon as any one of the branched paths is short-circuited, thereby preventing the short-circuited branched path from affecting the normal operation of the other branched paths, thus further assuring the heat-dissipation efficacy of the fan system.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A fan system, electrically connected to a power supply, for receiving a power generated from the power supply, comprising:
at least one fan;
a driving circuit electrically connected to the fan and receiving the power to drive the fan;
at least one protecting device electrically connected with the fan; and
a protecting circuit electrically connected between the protecting device and the driving circuit, wherein when one fan is short-circuited, the protecting circuit outputs a current value larger than a current-limited value of the protecting device.

2. The fan system of claim 1, wherein the protecting device is a fuse.

3. The fan system of claim 1, wherein the protecting circuit is a capacitor.

4. The fan system of claim 1, wherein the protecting circuit comprises a plurality of capacitors connected in parallel.

5. The fan system of claim 1, wherein the driving circuit comprises a switch device and a driving device, the switch device is electrically connected between the power supply and the protecting circuit, the driving device is electrically connected between the power supply and the switch device, and the driving device is used for turning on the switch device so as to transmit the power to the protecting circuit.

6. The fan system of claim 5, wherein said switch device is a transistor, a P-channel Metal-Oxide Semiconductor Field Effect Transistor (PMOSFET), or an N-channel Metal-Oxide Semiconductor Field Effect Transistor (NMOSFET).

7. The fan system of claim 5, wherein the driving device is an integrated circuit (IC), or a soft-start circuit.

8. The fan system of claim 5, wherein the driving device comprises a transistor, a capacitor, a plurality of resistors and a plurality of diodes.

9. A method for protecting a fan system, comprising steps of:
providing the fan system, wherein the fan system comprises a driving circuit, a protecting circuit, at least one protecting device and at least one fan, the driving circuit is used for driving the fan, the protecting circuit is electrically connected between the driving circuit and the fan, the protecting device is electrically connected with the fan; and
outputting a current value from the protecting circuit according to a current-limited value of the protecting device when one fan is short-circuited, wherein the current value is larger than the current-limited value of the protecting device;
whereby the protecting device fails when the fan is short-circuited, thus stopping an operation of the short-circuited fan.

10. The method of claim 9, wherein the protecting device is a fuse.

11. The method of claim 9, wherein the protecting circuit is a capacitor.

12. The method of claim 8, wherein the protecting circuit comprises a plurality of capacitors connected in parallel.

13. The method of claim 9, wherein the driving circuit comprises a switch device and a driving device, the switch device is electrically connected between the power supply and the protecting circuit, the driving device is electrically connected between the power supply and the switch device, and the driving device is used for turning on the switch device so as to transmit the power to the protecting circuit.

14. The method of claim 13, wherein the switch device is a transistor, a PMOSFET, or an NMOSFET.

15. The method of claim 13, wherein the driving device is an integrated circuit, or a soft-start circuit.

16. The method of claim 13, wherein the driving device comprises a transistor, a capacitor, a plurality of resistors and a plurality of diodes.
